(19) United States
(12) Patent Application Publication
(10) Pub. No.: US 2023/0026756 A1
(43) Pub. Date: Jan. 26, 2023

(54) Manufacturing Method of Monolithic Mirror

(71) Applicant: Nippon Telegraph and Telephone Corporation, Tokyo (JP)

(72) Inventors: Yusuke Saito, Musashino-shi, Tokyo (JP); Yuta Ueda, Musashino-shi, Tokyo (JP); Mitsuteru Ishikawa, Musashino-shi, Tokyo (JP)

(21) Appl. No.: 17/787,175

(22) PCT Filed: Dec. 23, 2019
(86) PCT No.: PCT/JP2019/050302

§ 371 Date: Jun. 17, 2022

(51) Int. Cl. G02B 6/136; G02B 5/08; G02B 6/13

(52) U.S. Cl. CPC G02B 6/136; G02B 5/0858; G02B 6/131; G02B 2006/12104

(57) ABSTRACT

After a step of etching a core layer, a lower cladding layer, and a substrate so that a recessed opening including one end of an optical waveguide is formed relative to a multilayer board and a step of forming mask layers on a top surface of the substrate including the opening, in a step, crystal is grown with respect to the mask layers in the opening, and a tilt surface to be used as the monolithic mirror is formed. An upper cladding layer is formed covering the core layer at the same time. Then, formation of an optical waveguide pattern, formation of the optical waveguide and an end surface of the optical waveguide, formation of a dielectric film for preventing reflection, and formation of a metal film on a surface of the tilt surface are executed.

### TECHNICAL FIELD

The present invention relates to a method of producing a monolithic mirror capable of producing a constant tilt angle with high accuracy.

### BACKGROUND ART

In the related art, there are many challenges in connecting light guided through an optical circuit to an external optical system. That is, the optical circuit is basically formed on a plane near a surface of a substrate, requiring connection at an end surface of the substrate. Thus, a manufacturing process such as cleaving, polishing, or antireflective coating at an end surface of an optical waveguide of the optical circuit formed on the substrate surface side is required, and, in addition, a mounting step such as alignment of a spatial optical system is required. It is a challenge to reduce the manufacturing cost of the optical circuit because these various steps are required.

In order to reduce the manufacturing cost of the optical circuit from the perspective described above, a method has been proposed in which light is emitted to a top surface of a substrate, and a technique for providing a grating coupler on an optical circuit and a technique for providing a mirror have been proposed.

The former technique using the grating coupler has an advantage that manufacturing can be performed with good yield because an established technique for producing a diffraction grating is applied. However, on the other hand, as a property of the diffraction grating, there are difficulties in optical characteristics, such as a high wavelength dependency and a tendency for more return light to occur.

The latter method using the mirror has advantages of optical characteristics such as weak wavelength dependence and less return light. However, on the other hand, it is difficult to produce the mirror precisely with good yield, unfortunately. In particular, a main factor in the difficulty is that a technique for forming a tilt angle of the mirror with high accuracy has not been established. If advantages in optical characteristics is utilized, the method will become a mainstream of future research and development.

Furthermore, the well-known technology according to the latter technique for providing a mirror is disclosed in, for example, NPL 1 and NPL 2. In the production of the mirror disclosed in NPL 1 and NPL 2, an inclined surface that becomes a mirror is formed by etching a substrate in a tilted state using a plasma.

However, according to the above technique, an angle deviation and the like actually tend to occur, and it is difficult to form a tilt angle with high accuracy, unfortunately.

### CITATION LIST

### Non Patent Literature

NPL 1: Sunghan Choi, Akio Higo, Masaru Zaitsu, Myung-Joon Kwack, Masakazu Sugiyama, Hiroshi Toshiyoshi, and Yoshiaki Nakano, “Development of a vertical optical coupler using a slanted etching of InP/InGaAsP waveguide,” IEICE Electronics Express, Vol. 10, No. 6, 1-8, 2013.
NPL 2: F. R. Gfeller, P. Buchmann, K. Datwyler, J. P. Reithmaier, P. Vettiger, and D. J. Webb, “50 mW CW-Operated Single-Mode Surface-Emitting AlGaAs Lasers with 45° Total Reflection Mirrors,” PHOTONICS TECHNOLOGY LETTERS, IEEE, Vol. 4, No. 7, JULY 1992 (pp. 698-700).

### SUMMARY OF THE INVENTION

The present invention has been made to solve the above difficulties. An object of an embodiment according to the present invention is to provide a method by which a monolithic mirror having a fixed tilt angle can be easily and precisely produced with good yield.

In order to achieve the object described above, an aspect of the present invention is a method of producing a monolithic mirror in which a core layer provided on a top surface of a substrate and a cladding layer provided on the top surface of the substrate so as to cover the core layer form the monolithic mirror by using a multilayer board forming an optical waveguide as a base material, and the method includes: etching the core layer, the cladding layer, and the substrate in such a way that a recessed opening including one end of the optical waveguide is formed relative to the multilayer board; forming a mask layer made of a dielectric on the top surface of the substrate including the recessed opening; and forming a tilt surface to be used as the monolithic mirror by growing crystal with respect to the mask layer in the recessed opening.

By employing the above process, a monolithic mirror having a fixed tilt angle is easily and precisely produced with good yield. This embodies cost reduction and enhancement of functions of an optical device by an optical circuit integrated with the monolithic mirror. This optical circuit can contribute greatly to a spread of an optical communication system.

### BRIEF DESCRIPTION OF DRAWINGS

FIG. 1 is a schematic view illustrating a multilayer board serving as a base material used in a method of producing a monolithic mirror according to a first embodiment of the present invention.

FIG. 1(a) is a plan view from a top surface direction of the multilayer board. FIG. 1(b) is a side view from a side surface direction in a longitudinal direction of the multilayer board.

FIG. 2 is a view illustrating the multilayer board in which a recessed opening has been formed by etching in an etching step following the removal of an upper cladding layer in the multilayer board illustrated in FIG. 1 and the film formation of a mask layer. FIG. 2(a) is a plan view from the top surface direction of the multilayer board in which the opening has been formed in the first half of the etching step of revealing a core layer. FIG. 2(b) is a cross-sectional view in the side surface direction in the longitudinal direction of the multilayer board in which the opening has been formed in the second half of the etching step of revealing a substrate 11.

FIG. 3 is a view illustrating propagation characteristics of an optical waveguide of the multilayer board described with reference to FIG. 2(b) due to reflection of light, in which an intersection of a distance of a horizontal axis and a distance of a longitudinal axis is a center of a mode field, by a monolithic mirror.

FIG. 4 is a view illustrating a relationship of a mirror height with respect to a mode field diameter in forming the monolithic mirror for the optical waveguide of the multilayer board described with reference to FIG. 2(b).

FIG. 5 is a plan view from the top surface direction of the multilayer board in a state in which a mask layer processing step has been performed after the mask layer has been formed in a second mask layer forming step following the removal of the mask layer of the multilayer board described with reference to FIG. 2(b).

FIG. 6 is a cross-sectional view in the side surface direction of the multilayer board in a state in which a tilt surface forming step has been performed on the multilayer board in which the mask layer for crystal growth has been formed on the top surface of the substrate in the mask layer processing step described with reference to FIG. 5.

FIG. 7 is a view illustrating the multilayer board concerning the formation of an optical waveguide pattern on a mask layer that has been newly formed after removal of the mask layer used in the tilt surface forming step described with reference to FIG. 6, and the formation of the optical waveguide and an end surface of the optical waveguide after the removal of the mask layer. FIG. 7(a) is a plan view from the top surface direction of the multilayer board in which the optical waveguide pattern has been formed on the mask layer that has been newly formed by optical waveguide patterning of the optical waveguide patterning step. FIG. 7(b) is a cross-sectional view in the side surface direction in the longitudinal direction of the multilayer board in which after removal of the newly formed mask layer, the optical waveguide and the end surface of the optical waveguide have been formed by etching in the etching step.

FIG. 8 is a cross-sectional view in the side surface direction in the longitudinal direction of the multilayer board in a state in which a dielectric film forming step has been performed on the multilayer board obtained after the etching step described with reference to FIG. 7(b).

FIG. 9 is a cross-sectional view in the side surface direction in the longitudinal direction of the multilayer board in a state in which a metal film forming step has been performed on the multilayer board obtained after the dielectric film forming step described with reference to FIG. 8.

FIG. 10 is a cross-sectional view in the side surface direction in the longitudinal direction of the multilayer board in a state in which another form of a core layer processing step applied in a method of producing a monolithic mirror according to a second embodiment of the present invention has been performed.

FIG. 11 is a cross-sectional view in the side surface direction in the longitudinal direction of the multilayer board in a state in which a metal film forming step which is a final step of a method of producing a monolithic mirror according to the second embodiment of the present invention has been performed.

### DESCRIPTION OF EMBODIMENTS

Hereinafter, a method of producing a monolithic mirror according to some embodiments of the present invention will be described in detail with reference to the drawings.

### First Embodiment

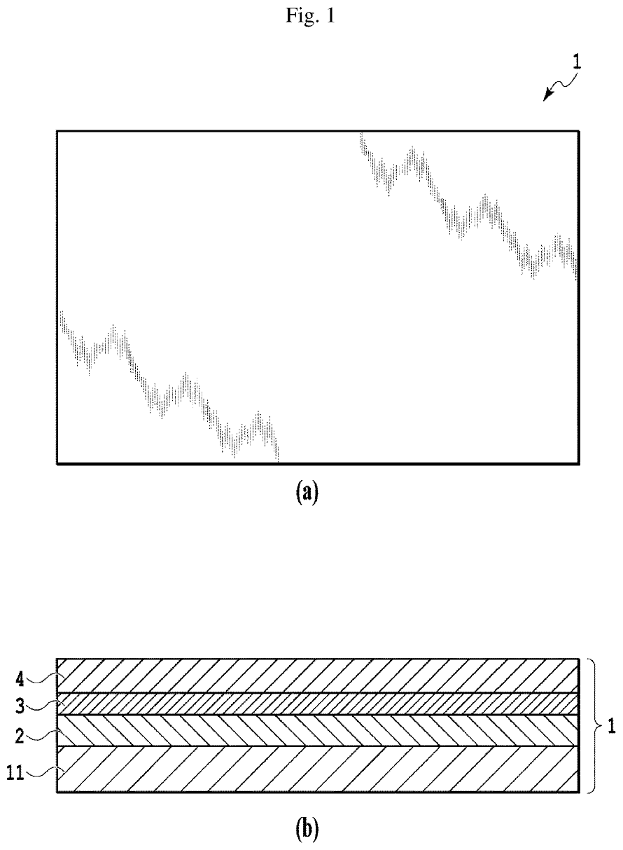

FIG. 1 is a schematic view illustrating a multilayer board 1 serving as a base material used in a method of producing a monolithic mirror according to a first embodiment of the present invention. FIG. 1(a) is a plan view from a top surface direction of the multilayer board 1. FIG. 1(b) is a side view from a side surface direction in a longitudinal direction of the multilayer board 1.

Referring to FIGS. 1(a) and 1(b), the multilayer board 1 is constituted by stacking a lower cladding layer 2, a core layer 3, and an upper cladding layer 4 in order on a top surface (surface), which is a main surface of a substrate 11. Here, the core layer 3 is covered by the lower cladding layer 2 and the upper cladding layer 4, but has a greater refractive index than these layers. Each layer forms an optical waveguide.

An InP substrate may be used for the substrate 11, and an InP crystal doped with an n-type or p-type doping material may be used for the lower cladding layer 2 and the upper cladding layer 4. For the core layer 3, a bulk material or a multiple quantum well according to crystal including any two or more types of III-V materials of In, Ga, As, P, and Al may be used as a material of the core layer 3. However, any material may be used for the lower cladding layer 2, the core layer 3, and the upper cladding layer 4 as long as the material is capable of crystal growth.

Hereinafter, a method of producing the monolithic mirror on the top surface of the InP substrate used for the substrate 11, regarding a side of the substrate 11 on which the core layer 3 is stacked as a top surface will be specifically described as a process for producing the monolithic mirror.

In the production process of the monolithic mirror, first, in an initial first etching step, the upper cladding layer 4 of the multilayer board 1 is removed by etching. Next, in an initial first mask layer forming step, a mask layer made of a dielectric is formed on the top surface of the multilayer board 1 from which the upper cladding layer 4 has been removed. A material commonly used as a mask for etching, such as SiO₂ or SiN, may be used as the material of this dielectric.

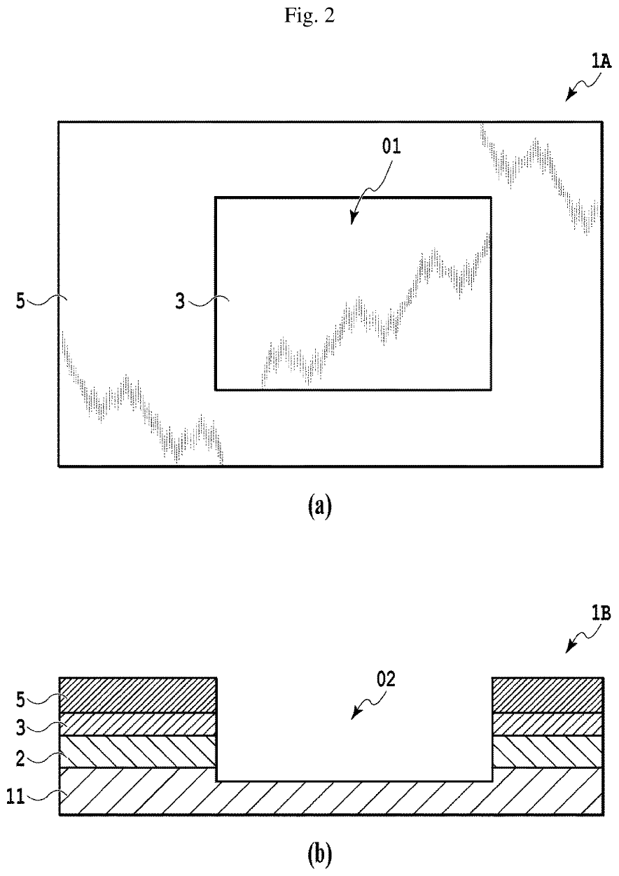

FIG. 2 is a view illustrating multilayer boards 1A and 1B in which recessed openings O1 and O2 has been formed by etching in a second etching step following the removal of the upper cladding layer 4 in the multilayer board 1 and the film formation of the mask layer. FIG. 2(a) is a plan view from the top surface direction of the multilayer board 1A in which the opening O1 has been formed in the first half of the second etching step of revealing the core layer 3. FIG. 2(b) is a cross-sectional view in the side surface direction in the longitudinal direction of the multilayer board 1B in which the opening O2 has been formed in the second half of the second etching step of revealing the substrate 11.

Referring to FIG. 2(a), the mask layer is etched in the first half of the second etching step with respect to the multilayer board 1 in which the upper cladding layer 4 is removed and the mask layer is formed. In this way, although the multilayer board 1A in which the opening O1 is formed in a mask layer 5 is obtained, a surface of the core layer 3 is revealed at the opening O1 of the mask layer 5.

Referring to FIG. 2(b), the core layer 3, the lower cladding layer 2, and the substrate 11 are continuously etched for the opening O1 of the mask layer 5 in the second half of the second etching step. As a result, the multilayer board 1B in which the recessed opening O2 is formed to include one end of the optical waveguide is obtained. The surface of the substrate 11 is revealed at the opening O2. A depth of the opening O2 is designed in advance, and not only the layers are etched but also the substrate 11 is etched. Various techniques used in a common semiconductor process can be applied to etching here, such as methods of using a plasma and methods of immersion in an etching solution.

Furthermore, a depth of etching varies with a design value relating to a spread angle of emitted light from an end surface of the optical waveguide and a distance between the end surface of the optical waveguide and the monolithic mirror formed. Furthermore, the depth of etching may be smaller as the spread angle of the emitted light is smaller. The etching depth may be smaller as the distance between the end surface of the optical waveguide and the monolithic mirror is smaller. In general, the spread angle of the emitted light at the end surface of the optical waveguide becomes smaller as a mode field diameter (hereinafter referred to as “MFD”) inside the optical waveguide decreases. Thus, it is assumed that a tilt surface used as the monolithic mirror based on the opening O2 is formed with respect to the multilayer board 1B having the optical waveguide.

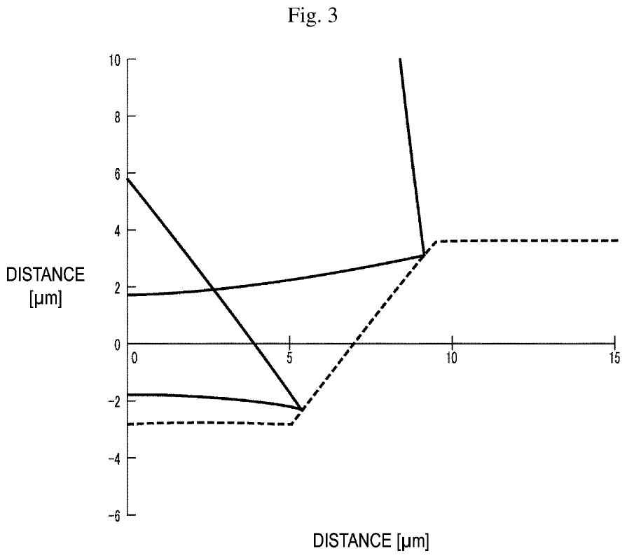

FIG. 3 is a view illustrating propagation characteristics of the optical waveguide of the multilayer board 1B by reflection by the monolithic mirror of light in which an intersection of a distance [μm] of a horizontal axis (X-axis) and a distance [μm] of a longitudinal axis (Y-axis) is a center of a mode field. However, in FIG. 3, X=0 is the end surface of the optical waveguide, and the propagation characteristics are shown in a case where light is emitted to a free space in a direction in which X>0 and reflected by the monolithic mirror.

In addition, in FIG. 3, the solid line indicates a position where light intensity is 1/e² (e indicates the number of Napier) of the center of the mode field, and the dashed line indicates an outermost surface (including the tilt surface) of the multilayer board 1B. In FIG. 3, the MFD of the emitted light from the end surface of the optical waveguide is 3.5 μm, and the distance between the end surface of the optical waveguide and the monolithic mirror is 5 μm. Furthermore, Y=0 corresponds to a top surface of the lower cladding layer 2 prior to the etching step, and in the above conditions, the etching depth is 2.8 μm.

Referring to FIG. 3, it can be seen that a suitable etching depth in accordance with MFD is required to efficiently emit light above the multilayer board 1B. Even if the etching depth is too deep or too shallow, vignetting of light occurs and causes light loss.

Likewise, if a height of the monolithic mirror is insufficient for the spread of light, it is a cause of light loss, and therefore, a mirror with a height corresponding to the design needs to be produced.

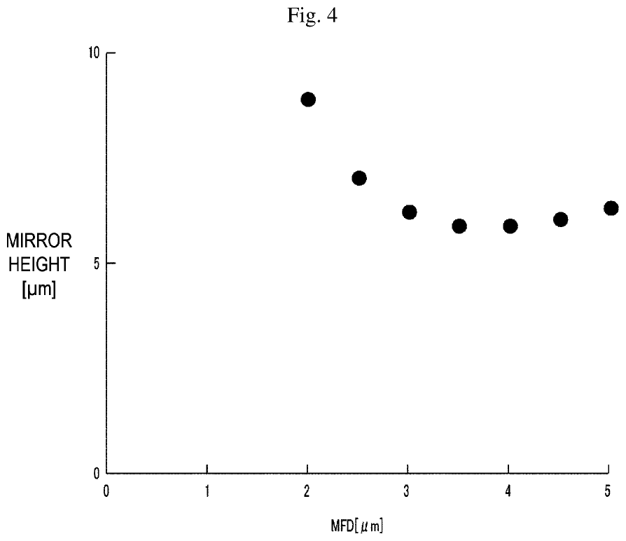

FIG. 4 is a view illustrating a relationship of the mirror height [μm] with respect to the MFD [μm] in forming the monolithic mirror for the optical waveguide of the multilayer board 1B.

Generally, a design value of the mirror height has a tolerance of 0.5 μm and has some margin for upper and lower manufacturing errors. Referring to FIG. 4, it can be seen that the mirror height is in a range of 6 μm to 9 μm while the MFD is in a range of about 2 μm to 5 μm. In other words, according to the characteristics of FIG. 4, if the MFD is 3.5 μm, the mirror height is about 6 μm.

In the production process of the monolithic mirror, in addition, the mask layer 5 of the multilayer board 1B is removed, and then, after the mask layer made of the dielectric is formed again over the entire surface of the substrate 11 in a second mask layer forming step, a mask layer processing step is performed. In the mask layer processing step, only a required portion of the opening O2 is left in the mask layer.

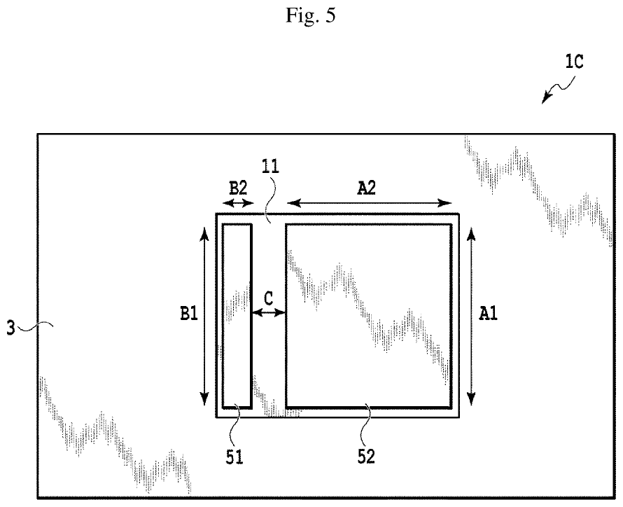

FIG. 5 is a plan view from a top surface direction of a multilayer board 1C in a state in which the mask layer processing step has been performed after the mask layer has been formed in the second mask layer forming step following the removal of the mask layer 5 of the multilayer board 1B.

Referring to FIG. 5, in the mask layer processing step, the mask layer formed in the second mask layer forming step is processed. As a result, the multilayer board 1C in a state in which a small mask layer 51 for crystal growth and a large mask layer 52 for crystal growth remain on the top surface of the substrate 11 is obtained in a region of the opening O2 in which the multilayer board 1B is etched. In this state, the core layer 3 is revealed in a wide frame shape at a peripheral edge portion of the opening O2 of the multilayer board 1C.

Furthermore, a core layer processing step may be performed so that the core layer 3 gradually narrows toward one side of the opening O1 serving as a light emitting side of the optical waveguide while the mask layer 5 of the multilayer board 1B is removed prior to performing this mask layer processing step. In this core layer processing step, separately, the core layer 3 is processed into a sloping structure by etching in the etching step, for example, such that a film thickness of the core layer 3 is changed so as to continuously decrease toward one side of the opening O1 in the longitudinal direction of the optical waveguide. As a result, the core layer 3 having a sloping structure is produced as a spot size converter that expands the MFD of light guided through the optical waveguide.

The mask layers 51 and 52 are provided to be separated from each other by an interval of C In the mask layer 52, a length in a transverse direction of the substrate 11 is A1 μm, and a width in a longitudinal direction of the substrate 11 is A2 μm. In the mask layer 51, a length in the transverse direction of the substrate 11 is B1 μm, and a width in the longitudinal direction of the substrate 11 is B2 μm.

Subsequently, in a tilt surface forming step, the tilt surface used as the monolithic mirror is formed by crystal growth with respect to the multilayer board 1C.

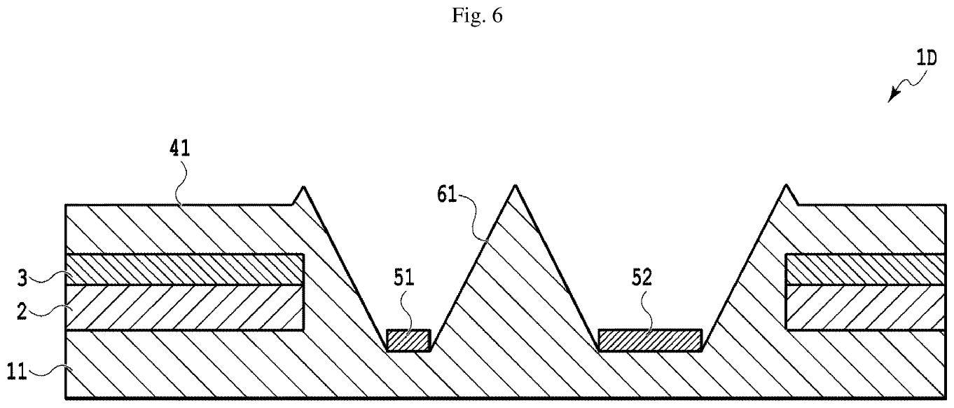

FIG. 6 is a cross-sectional view in the side surface direction of the multilayer board 1D in a state in which the tilt surface forming step is performed on the multilayer board 1C in which the mask layers 51 and 52 have been formed on the top surface of the substrate 11 in the mask layer processing step.

Referring to FIG. 6, in the tilt surface forming step, crystal i-InP is grown on the multilayer board 1C obtained in the mask layer processing step to form a tilt surface 61 used as the monolithic mirror. This tilt surface 61 is formed in accordance with the property of selective growth in which crystal grows only in an unmasked portion when a portion of the substrate 11 is covered with the mask layers 51 and 52 in the opening O2 and crystal growth is performed. In addition, an upper cladding layer 41 is formed covering the core layer 3 at the same time. Furthermore, the upper cladding layers 4 and 41 and the lower cladding layer 2 described above can be considered as cladding layers that cover the core layer 3 together.

By the way, a crystal growth step in which crystal growth is performed in which a p-type or n-type semiconductor above the core layer 3 is replaced with a nondoped semiconductor is often originally incorporated into a manufacturing process of an optical device. Accordingly, in such a case, it is possible to produce a monolithic mirror without substantially increasing the number of crystal growth.

In the tilt surface forming step, a supply material that has reached the top surfaces of the mask layers 51 and 52 during growth of the crystal i-InP moves on the top surfaces of the mask layers 51 and 52 and grows on the top surface of the multilayer board 1C around the mask layers 51 and 52. At this time, as a mask area of the mask layers 51 and 52 is larger, the height of growth of the moved supply material increases more easily because the moved supply material gathers around the mask layers 51 and 52. A region sandwiched by masks of the mask layers 51 and 52 is advantageous in terms of high growth because the supply material particularly easily gathers in the region.

Such an effect is referred to as selective growth, which results in the multilayer board 1D that can use the tilt surface 61, formed between the mask layers 51 and 52, as the monolithic mirror. In the selective growth, the tilt surface 61 can be formed in accordance with a crystal orientation. Furthermore, FIG. 6 illustrates the positional relationship and shapes of the mask layers 51 and 52 and the tilt surface 61. The tilt surface 61 has a constant angle, and when the crystal orientation of the substrate 11 is (1, 0, 0), the angle of the tilt surface 61 may be about 55 degrees.

In order to increase the height of the monolithic mirror, the value of the interval C between the mask layers 51 and 52 is preferably smaller, and it is desirable that the value is set to a value matching a design of 2.4 μm or more. Because an angle formed between the tilt surface 61 and the multilayer board 1D is constant, a maximum value of the height of the monolithic mirror can be geometrically calculated from the value of the interval C. For example, when the interval C is 2.4 μm, the maximum value of the height of the monolithic mirror is about 1.7 μm. Generally, a thickness of the upper cladding layer 41 is often designed to be about 1.7 to 1.8 μm. Because of this, the interval C less than 2.4 μm disables an effect of producing the monolithic mirror that would have been obtained from the high height of the monolithic mirror, and thus, the lower limit of the interval C is set to 2.4 μm.

In addition, the width B2 of the mask layer 51 is preferably set to 20 μm or less. The reason for this is because, as described above, the smaller the distance between the end surface of the optical waveguide and the monolithic mirror, the more preferable.

Furthermore, due to a finite movement length of the supply material, there is no effect even if the masks of the mask layers 51 and 52 are larger than necessary. On the other hand, since a large mask reduces the number of cavities in device molding, it is envisaged that manufacturing efficiency is adversely affected. Accordingly, dimensions of the masks of the mask layers 51 and 52 need to be set to suitable values. In general, when the optical waveguides are arranged side-by-side on the top surface of the wafer in the production, the interval is at most about 500 μm. Thus, it is desirable that the length A1 and the width A2 of the mask layer 52, which are the dimensions of the masks of the mask layers 51 and 52 for crystal growth, and the length B1 in the mask layer 51 are set to 500 μm or less.

In the production process of the monolithic mirror, subsequently, after the mask layers 51 and 52 on the surface of the multilayer board 1D are removed, the mask layer made of the dielectric is formed again over the entire surface of the substrate 11 in a third mask layer forming step. In addition, in an optical waveguide patterning step, the optical waveguide pattern is patterned with respect to the formed mask layer. Then, in a third etching step, the top surface of the substrate 11 on which an optical waveguide pattern has been patterned is etched to remove the mask layer and form the optical waveguide and the end surface of the optical waveguide.

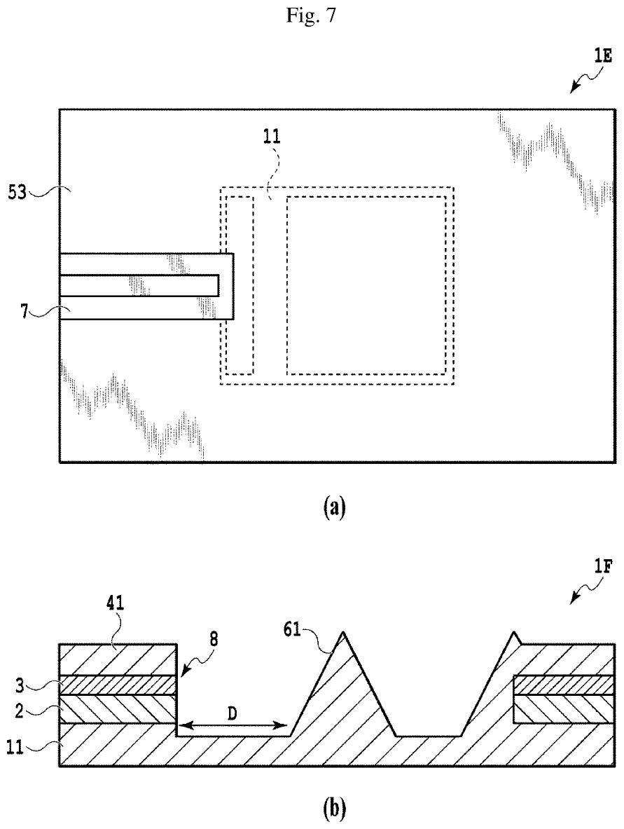

FIG. 7 is a view illustrating the multilayer boards 1E and 1F concerning the formation of an optical waveguide pattern 7 on a mask layer 53 that has been newly formed after the removal of the mask layers 51 and 52, and the formation of the optical waveguide and an end surface 8 of the optical waveguide after the removal of the mask layer 53. FIG. 7(a) is a plan view from the top surface direction of the multilayer board 1E in which the optical waveguide pattern 7 has been formed on the mask layer 53 that has been newly formed by optical waveguide patterning of the optical waveguide patterning step. FIG. 7(b) is a cross-sectional view in the side surface direction in the longitudinal direction of the multilayer board 1F in which after removal of the newly formed mask layer 53, the optical waveguide and the end surface 8 of the optical waveguide has been formed by etching in the third etching step.

Referring to FIG. 7(a), in the optical waveguide patterning step, the optical waveguide pattern 7 is formed on the mask layer 53 that has been newly formed by optical waveguide patterning. As a result, the multilayer board 1E having the optical waveguide pattern 7 surrounded by the mask layer 53 is obtained. However, the optical waveguide pattern 7 in this case is formed so as to reach within the region of the opening O2 where the mask layer 51 has been present from one end in the transverse direction of the substrate 11.

Referring to FIG. 7(b), in the third etching step, after the mask layer 53 of the multilayer board 1E is removed by etching, the optical waveguide and the end surface 8 of the optical waveguide are formed. As a result, the multilayer board 1F having the tilt surface 61 and the upper cladding layer 41 and having the optical waveguide and the end surface 8 of the optical waveguide is obtained. In this third etching step, an end surface forming step of forming at least one end surface 8 of the optical waveguide by etching is performed. In this case, a distance D between the end surface 8 of the optical waveguide and a lowermost portion of the tilt surface 61 that becomes the monolithic mirror is determined. Considering the spread of light, the smaller the distance D, the more preferable, as described above. Thus, in the description referring to FIG. 3, a case of the distance D=5 μm on the design is illustrated. In consideration of the tolerance and the like during manufacturing, the distance D is preferably set to 20 μm or less.

In the production process of the monolithic mirror, in addition, a dielectric film is formed over the entire top surface of the multilayer board 1F. Thereafter, a photoresist is patterned by photolithography so that the dielectric film remains on the end surface 8 of the optical waveguide and a surface of the multilayer board 1F (substrate 11) between the end surface 8 of the optical waveguide and the tilt surface 61, and then etching is performed. As a result, a dielectric film forming step of forming a dielectric film for preventing reflection is performed.

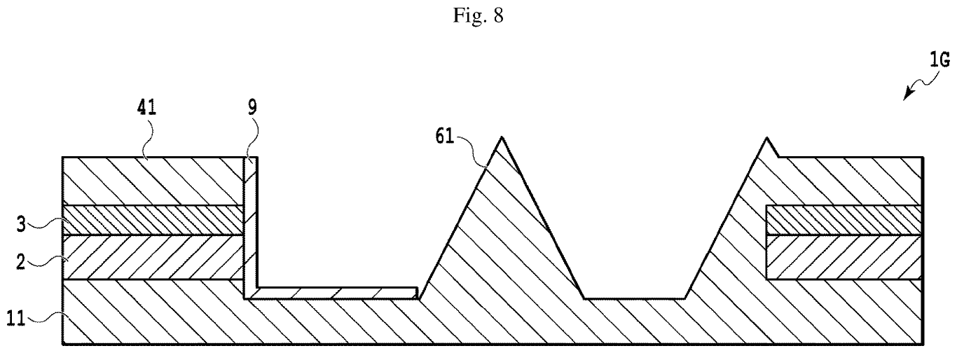

FIG. 8 is a cross-sectional view in the side surface direction in the longitudinal direction of a multilayer board 1G in a state in which a dielectric film forming step has been performed on the multilayer board 1F obtained after the third etching step described with reference to FIG. 7(b).

Referring to FIG. 8, in a state in which the dielectric film forming step has been performed, the multilayer board 1G in which a dielectric film 9 for preventing reflection is formed is obtained on the end surface 8 of the optical waveguide and the surface of the multilayer board 1F (substrate 11) between the end surface 8 of the optical waveguide and the tilt surface 61. When a film thickness of the dielectric film 9 is set to the film thickness that can cancel a wavelength of light by interference, the dielectric film 9 can be used as an antireflective film, and in such a case, stray light can be prevented from occurring. Furthermore, the dielectric film 9 can be applied as an antireflective film even when the dielectric film 9 has a multilayer film structure formed by stacking a plurality of dielectric materials.

Finally, the photoresist is patterned by photolithography so that a nearby portion of the tilt surface 61 is an opening O3, and metal is deposited on a surface of the tilt surface 61 and then lifted off to remove the photoresist. As a result, a metal film forming step of forming a metal film is performed.

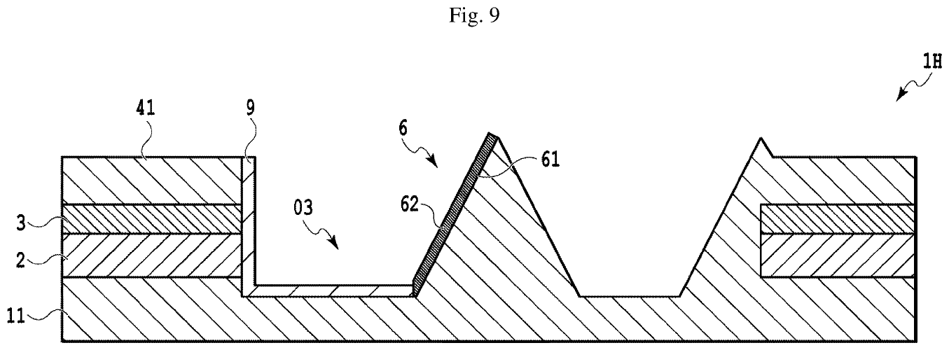

FIG. 9 is a cross-sectional view in the side surface direction in the longitudinal direction of the multilayer board 1H in a state in which the metal film forming step has been performed on the multilayer board 1G obtained after the dielectric film forming step described with reference to FIG. 8.

Referring to FIG. 9, in a state in which the aforementioned metal film forming step has been performed, the surface of the tilt surface 61 is covered with a metal film 62, and the multilayer board 1H having a monolithic mirror 6 whose nearby portion is the opening O3 is obtained. Furthermore, in the metal film forming step, in place of such a technique, a technique for depositing metal on the entire top surface of the multilayer board 1G and then removing metal from a portion other than the tilt surface 61 by etching may be performed. In this way, the production process of the monolithic mirror 6 according to the first embodiment having a structure in which the monolithic mirror 6 is integrated in front of an advancing direction of the light of the optical waveguide is completed. If such a production process is performed, the monolithic mirror 6 having the tilt angle 61 can be easily and precisely produced with good yield.

In the metal film forming step herein, the monolithic mirror 6 may be produced by stacking a plurality of dielectric materials having different refractive indices on the surface of the tilt surface 61 in place of the metal film 62 to form a dielectric multilayer film having high reflectance. In such cases as well, a technique can be applied in which a photoresist is patterned by photolithography such that the nearby portion of the tilt surface 61 is the opening O3, and lift-off is performed to remove the photoresist after dielectric materials having different refractive indices are stacked. In addition, a technique can be applied in which dielectric materials having different refractive indices are stacked on the entire top surface of the multilayer board 1G, and then a material of a dielectric multilayer film in a portion other than the tilt surface 61 is removed by etching. In other words, various techniques can be applied to film the dielectric multilayer film on the surface of the tilt surface 61.

### Second Embodiment

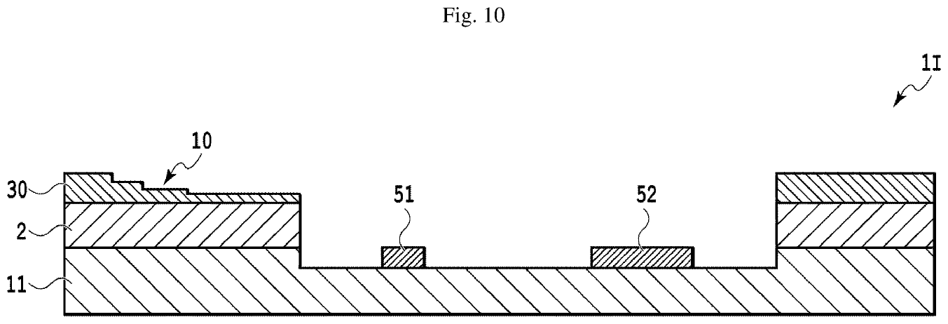

FIG. 10 is a cross-sectional view in a side surface direction in a longitudinal direction of a multilayer board 1I in a state in which another form of a core layer processing step applied in a method of producing a monolithic mirror according to a second embodiment of the present invention has been performed. However, the multilayer board 1I is illustrated as a state in which mask layers 51 and 52 for crystal growth are formed on a top surface of a substrate 11 in a subsequent mask layer processing step.

Referring to FIG. 10, this core layer processing step is another form described above, and is performed in a state where a mask layer 5 of a multilayer board 1B is removed prior to performing the mask layer processing step described with reference to FIG. 5 in the first embodiment. The core layer processing step in this embodiment is the same in that a core layer 30 gradually narrows toward one side of an opening O1 serving as a light emitting side of an optical waveguide. However, in this core layer processing step, separately, the core layer 30 is processed into a stepped structure by etching in the etching step in a manner that a film thickness of the core layer 30 is changed so as to gradually decrease toward one side of the opening O1 in the longitudinal direction of the optical waveguide. As a result, the core layer 30 having a stepped structure is produced as a spot size converter 10 that expands an MFD of light guided through the optical waveguide.

After performing another form of the core layer processing step described above, the same steps as described in the first embodiment may be performed sequentially. In this way, a production process of a monolithic mirror 6 according to the second embodiment having a structure in which the monolithic mirror 6 is integrated in front of an advancing direction of the light of the optical waveguide is completed.

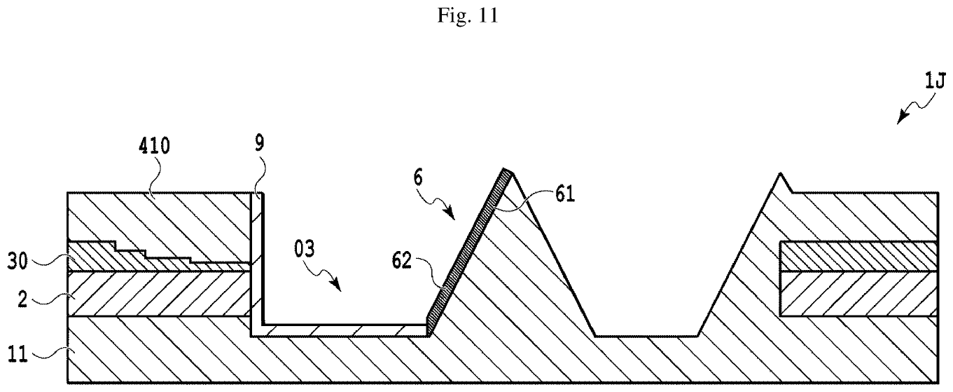

FIG. 11 is a cross-sectional view in the side surface direction in the longitudinal direction of a multilayer board 1J in a state in which a metal film forming step which is a final step is performed.

Referring to FIG. 11, in a state in which a metal film forming step similar to that of the first embodiment is performed, a surface of a tilt surface 61 is covered with a metal film 62, and the multilayer board 1J having the monolithic mirror 6 whose nearby portion is an opening O3 is obtained. In the multilayer board 1J, an upper cladding layer 410 formed on an upper side of the core layer 30 at the same time as the formation of the tilt surface 61 in a tilt surface forming step has an inverted stepped shape joined to a stepped shape of the core layer 30, and a nearby portion of the tilt surface 61 is the opening O3. Furthermore, also in this metal film forming step, a technique for depositing metal on the entire top surface of the multilayer board obtained after a dielectric film forming step and then removing metal from a portion other than the tilt surface 61 by etching may be performed instead.

Similarly, instead of performing the metal film forming step herein, the monolithic mirror 6 may be produced by stacking a plurality of dielectric materials having different refractive indices on the surface of the tilt surface 61 in place of the metal film 62 to form a dielectric multilayer film having high reflectance. In such cases as well, a technique can be applied in which a photoresist is patterned by photolithography such that the nearby portion of the tilt surface 61 is the opening O3, and lift-off is performed to remove the photoresist after dielectric materials having different refractive indices are stacked. In addition, a technique can be applied in which dielectric materials having different refractive indices are stacked on the entire top surface of the multilayer board obtained after the dielectric film forming step, and then a material of a dielectric multilayer film in a portion other than the tilt surface 61 is removed by etching. In other words, various techniques can be applied to film the dielectric multilayer film on the surface of the tilt surface 61.

1. A method of producing a monolithic mirror in which a core layer provided on a top surface of a substrate and a cladding layer provided on the top surface of the substrate so as to cover the core layer form the monolithic mirror by using a multilayer board forming an optical waveguide as a base material, the method comprising:
etching the core layer, the cladding layer, and the substrate in such a way that a recessed opening including one end of the optical waveguide is formed relative to the multilayer board;
forming a mask layer made of a dielectric on the top surface of the substrate including the recessed opening; and
forming a tilt surface to be used as the monolithic mirror by growing crystal with respect to the mask layer in the recessed opening.

2. The method of producing a monolithic mirror according to claim 1, wherein, in the etching of the core layer, the cladding layer, and the substrate, at least one end surface of the optical waveguide is formed by etching.

3. The method of producing a monolithic mirror according to claim 1, wherein in the forming of the tilt surface, an upper cladding layer is formed on an upper side of the core layer in the optical waveguide at the same time as the formation of the tilt surface.

4. The method of producing a monolithic mirror according to claim 1, further comprising forming a dielectric film for preventing reflection on an end surface of the optical waveguide and a surface of the substrate between the end surface of the optical waveguide and the tilt surface.

5. The method of producing a monolithic mirror according to claim 4, further comprising forming a metal film on a surface of the tilt surface.

6. The method of producing a monolithic mirror according to claim 4, further comprising forming a dielectric multilayer film having high reflectance on a surface of the tilt surface.

7. The method of producing a monolithic mirror according to claim 5, wherein, in the etching of the core layer, the cladding layer, and the substrate, the core layer is processed to have a sloping structure by changing a film thickness of the core layer so as to be continuously reduced toward one side of the recessed opening in a longitudinal direction of the optical waveguide.

8. The method of producing a monolithic mirror according to claim 5, wherein in the etching of the core layer, the cladding layer, and the substrate, the core layer is processed to have a stepped structure by changing a film thickness of the core layer so as to be gradually reduced toward one side of the recessed opening in a longitudinal direction of the optical waveguide.
